(19) United States
(12) Patent Application Publication
(10) Pub. No.: US 2026/0122394 A1
(43) Pub. Date: Apr. 30, 2026

(54) METHODS FOR DETECTING WEARING POSITIONS OF EARPHONES, EARPHONES, AND ELECTRONIC DEVICES

(71) Applicant: SHENZHEN SHOKZ CO., LTD., Shenzhen, Guangdong (CN)

(72) Inventors: Liang WANG, Shenzhen (CN); Libin ZHOU, Shenzhen (CN); Chu WANG, Shenzhen (CN)

(73) Assignee: SHENZHEN SHOKZ CO., LTD., Shenzhen, Guangdong (CN)

(21) Appl. No.: 19/433,188

(22) Filed: Dec. 26, 2025

Related U.S. Application Data
(63) Continuation of application No. PCT/CN2024/102585, filed on Jun. 28, 2024.

(51) Int. Cl. H04R 1/10

(52) U.S. Cl. CPC H04R 1/1041; H04R 1/1016

(57) ABSTRACT

The present disclosure relates to a method for detecting a wearing position of an earphone, an earphone, and an electronic device. The wearing position includes a left ear or a right ear of a user. The method includes: determining whether the earphone is in a wearing state, in response to the earphone is in the wearing state, acquiring a communication performance parameter of the earphone; and determining the wearing position of the earphone according to the communication performance parameter of the earphone.

### CROSS-REFERENCE TO RELATED APPLICATIONS

This application is a Continuation of International Patent Application No. PCT/CN2024/102585, filed on Jun. 28, 2024, the entire contents of which are incorporated herein by reference.

### TECHNICAL FIELD

The present disclosure generally relates to a field of consumer electronics, and in particular to a method for detecting a wearing position of an earphone, an earphone, and an electronic device.

### BACKGROUND

In related technologies, an acceleration sensor and/or a gyroscope are typically disposed in an earphone to detect a wearing position of the earphone, which increases hardware costs. Additionally, the acceleration sensor and/or the gyroscope occupy space, which is not conducive to achieving miniaturization of the earphone.

### SUMMARY

One or more embodiments of the present disclosure provide a method for detecting a wearing position of an earphone. The wearing position includes a left ear or a right ear of a user. The method includes: determining whether the earphone is in a wearing state; in response to determining that the earphone is in the wearing state, acquiring a communication performance parameter of the earphone; and determining the wearing position of the earphone according to the communication performance parameter of the earphone.

In some embodiments, the earphone is in communication with an electronic device, the acquiring a communication performance parameter of the earphone includes: acquiring a first communication performance parameter of the earphone based on a signal strength of a communication signal between the earphone and the electronic device when the electronic device is at a first position relative to the head of the user; and acquiring a second communication performance parameter of the earphone based on the signal strength of the communication signal between the earphone and the electronic device when the electronic device is at a second position relative to the head of the user; the determining the wearing position of the earphone according to the communication performance parameter of the earphone includes: determining the wearing position of the earphone according to a comparison result of the first communication performance parameter and the second communication performance parameter, wherein the first position and the second position are different, a difference exists between the first communication performance parameter and the second communication performance parameter.

In some embodiments, the first position and the second position are located on opposite sides of a sagittal plane of the user, and the determining the wearing position of the earphone according to a comparison result of the first communication performance parameter and the second communication performance parameter includes: in response to determining that the first communication performance parameter is superior to the second communication performance parameter, determining that the wearing position of the earphone and the first position are located on the same side of the sagittal plane; in response to determining that the second communication performance parameter is superior to the first communication performance parameter, determining that the wearing position of the earphone and the second position are located on the same side of the sagittal plane.

In some embodiments, the shortest linear distance between the electronic device and the tragus is less than or equal to 8 mm when the electronic device is at the first position, and the shortest linear distance between the electronic device and the tragus is less than or equal to 8 mm when the electronic device is at the second position.

In some embodiments, there is a pair of earphones, the acquiring a communication performance parameter of the earphone includes: in response to determining that the pair of earphones both are in the wearing state, acquiring the communication performance parameter of each earphone of the pair of earphones; the determining the wearing position of the earphone according to the communication performance parameter of the earphone includes: determining the wearing position of each earphone of the pair of earphones according to a comparison result of the communication performance parameters of the pair of earphones.

In some embodiments, for each earphone of the pair of earphones, an antenna structure of the earphone is configured such that the communication performance parameter of the earphone when worn on one of the left ear and the right ear is superior to the communication performance parameter when worn on the other of the left ear and the right ear; the determining the wearing position of each earphone of the pair of earphones according to a comparison result of the communication performance parameters of the pair of earphones includes: determining that the wearing position of one of the pair of earphones having a superior communication performance parameter is the one of the left ear and the right ear, and the wearing position of the other of the pair of earphones is the other of the left ear and the right ear.

In some embodiments, each earphone of the pair of earphones is in communication with an electronic device, and the acquiring the communication performance parameter of each earphone of the pair of earphones includes: for each earphone of the pair of earphones, acquiring the communication performance parameter of the earphone based on a signal strength of a communication signal between the earphone and the electronic device when the electronic device is at a preset position relative to the head of the user, and the preset position is located on a sagittal plane of the user.

In some embodiments, the communication performance parameter is a received signal strength indication (RSSI), and a difference between the RSSIs of the pair of earphones is a range of 5 dB to 10 dB.

In some embodiments, the earphone is in communication with an electronic device, and the acquiring the communication performance parameter of each earphone of the pair of earphones includes: for each earphone of the pair of earphones, acquiring the communication performance parameter of the earphone based on a signal strength of a communication signal between the earphone and the electronic device when the electronic device is at a preset position relative to the head of the user, wherein the preset position is configured such that a difference exists between the communication performance parameter of the earphone worn on the left ear and the communication performance parameter of the earphone worn on the right ear.

In some embodiments, the preset position is located on one side of a sagittal plane of the user; the determining the wearing position of each earphone of the pair of earphones according to a comparison result of the communication performance parameters of the pair of earphones includes: in response to determining that the communication performance parameter of one of the pair of earphones is superior to the communication performance parameter of the other of the pair of earphones, determining that the wearing position of the one of the pair of earphones and the preset position are located on the same side of the sagittal plane, and the wearing position of the other of the pair of earphones is located on an opposite side of the sagittal plane relative to the preset position.

In some embodiments, the preset position includes a first position and a second position located on opposite sides of the sagittal plane, and the method further includes: in response to determining that a detection result of the wearing position obtained based on the first position is different from a detection result of the wearing position obtained based on the second position, generating an error prompt.

In some embodiments, the earphone is in communication with an electronic device, and the acquiring a communication performance parameter of the earphone further includes: generating a predetermined action prompt to cause the user to change a relative position between the electronic device and the head of the user according to a predetermined manner.

One or more embodiments of the present disclosure provide an earphone, including a processor and a storage device, wherein the storage device stores a computer program, and the processor is configured to execute the computer program to implement any method described above.

One or more embodiments of the present disclosure provide an electronic device, configured to communicate with an earphone, and including a processor and a storage device, wherein the storage device stores a computer program, and the processor is configured to execute the computer program to implement any method described above.

In some embodiments of the present disclosure, by obtaining the communication performance parameter of the earphone and determining the wearing position of the earphone according to the communication performance parameter of the earphone, it is not necessary to additionally set detection elements such as an acceleration sensor and/or a gyroscope in the earphone. Compared with solutions in related technologies, some embodiments of the present disclosure can reduce hardware costs and be beneficial in achieving the miniaturization of the earphone.

### BRIEF DESCRIPTION OF THE DRAWINGS

To more clearly illustrate the technical solutions in the embodiments of the present disclosure, the following briefly describes the drawings required for describing the embodiments. Obviously, the drawings in the following description show merely some embodiments of the present disclosure, and a person of ordinary skill in the art may derive other drawings from these drawings without creative efforts.

FIG. 1 shows a state of an earphone worn on an ear of a user according to some embodiments of the present disclosure;

FIG. 2 is a flowchart illustrating an exemplary process of a method for detecting a wearing position of an earphone according to some embodiments of the present disclosure;

FIG. 3 is a schematic diagram of a human body section;

FIG. 4 is a flowchart illustrating an exemplary process of operation S120 according to some embodiments of the present disclosure;

FIG. 5 is a flowchart illustrating an exemplary process of operation S131 according to some embodiments of the present disclosure;

FIG. 6 is a flowchart illustrating an exemplary process of a method for detecting a wearing position of an earphone according to some embodiments of the present disclosure;

FIG. 7 is a block diagram of an earphone according to some embodiments of the present disclosure;

FIG. 8 is a block diagram of an electronic device according to some embodiments of the present disclosure.

### DETAILED DESCRIPTION

The present disclosure is further described in detail below with reference to the accompanying drawings and embodiments. It is specifically pointed out that the following embodiments are only used to illustrate the present disclosure, but do not limit the scope of the present disclosure. Similarly, the following embodiments are only some embodiments of the present disclosure rather than all embodiments. All other embodiments obtained by a person of ordinary skill in the art based on the embodiments of the present disclosure without creative efforts shall fall within the protection scope of the present disclosure.

In the present disclosure, reference to “an embodiment” means that a particular feature, structure, or characteristic described in connection with the embodiment may be included in at least one embodiment of the present disclosure. The phrase appears in various places in the specification, which do not necessarily refer to the same embodiment, and is not an independent or alternative embodiment mutually exclusive with other embodiments. A person skilled in the art explicitly and implicitly understands that the embodiments described herein may be combined with other embodiments.

In the present disclosure, the terms “first”, “second”, and “third” are used for descriptive purposes only, and cannot be understood as indicating or implying relative importance or implicitly indicating the quantity of the indicated technical features. Thus, features defined with “first”, “second”, and “third” may explicitly or implicitly include at least one such feature. In the description of the present disclosure, “a plurality of” means at least two, for example, two, three, etc., unless otherwise explicitly and specifically defined. In addition, the terms “include” and “have” and any variations thereof are intended to cover a non-exclusive inclusion. For example, a process, method, system, product, or device that includes a series of operations or units is not limited to the listed operations or units, but optionally also includes operations or units that are not listed, or optionally also includes other operations or units inherent to these processes, methods, products, or devices.

Some embodiments of the present disclosure provide a method for detecting a wearing position of an earphone 1.

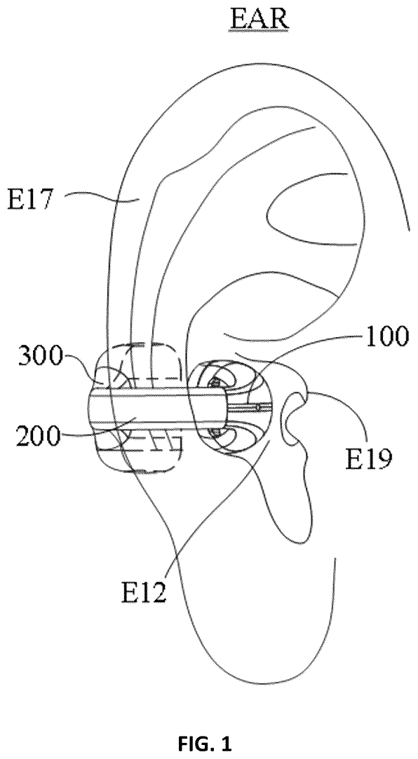

FIG. 1 shows a state of an earphone worn on an ear of a user according to some embodiments of the present disclosure. The earphone 1 may be an ear-clip earphone. As shown in FIG. 1, the earphone 1 includes a sound generating portion 100 for inserting into a concha E12 of a user, an abutting portion 300 for abutting behind the ear of the user, and an ear hook 200 connecting the sound generating portion 100 and the abutting portion 300. In a wearing state, the ear hook 200 may bypass a helix E17 of the user, the sound generating portion 100 and the abutting portion 300 form a clamping state on two sides of the helix E17 of the user, and the sound generating portion 100 is located in the concha E12.

In some embodiments, the sound generating portion 100 refers to a sound playback device, which is configured to convert an electrical signal into a sound signal and play the sound signal to a wearer. The abutting portion 300 and the sound generating portion 100 form a clamping state, so as to clamp and wear the entire earphone 1 on the ear of the user. A battery, a circuit board, and other components may be disposed in the abutting portion 300. In some embodiments, the battery may not be disposed in the abutting portion 300, and the battery may be installed in the sound generating portion 100, the above description falls within the scope easily understood by a person skilled in the art, and details are not described herein again.

In some embodiments, the earphone 1 may be another type of earphone that supports both wearing in a left ear and wearing in a right ear. It is easy to understand that the ear-clip earphone shown in FIG. 1 is merely an example and cannot be understood as a limitation to some embodiments of the present disclosure.

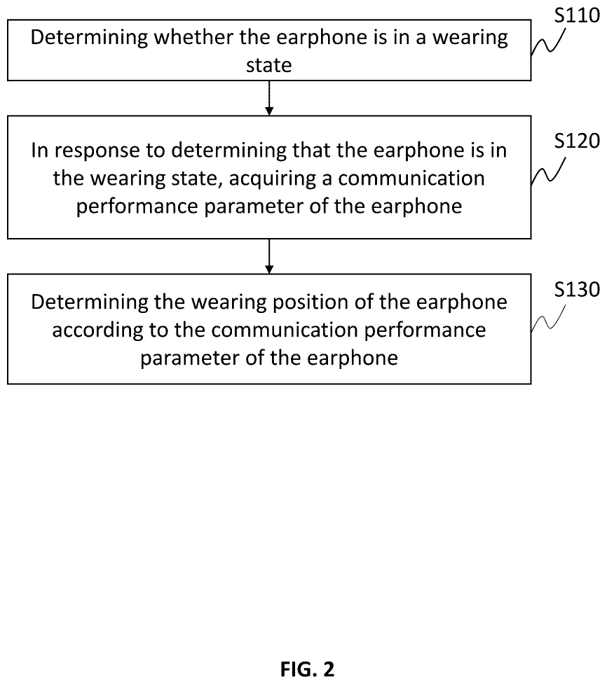

FIG. 2 is a flowchart illustrating an exemplary process of a method for detecting a wearing position of an earphone according to some embodiments of the present disclosure. In some embodiments, the wearing position includes a left ear or a right ear of a user. In some embodiments, the method may be performed by the earphone. In some embodiments, the method may also be performed by an electronic device that communicates with the earphone, for example, a mobile phone or a tablet, etc., and there is no limit here.

In some embodiments, the method includes the following operations.

In S110, whether the earphone is in a wearing state is determined.

The earphone being in the wearing state refers to that the earphone is worn on an ear of the user. A wearing detection module may be disposed in the earphone, and the wearing detection module in the earphone may be used to determine whether the earphone is in the wearing state. For example, the wearing detection module may be disposed on a circuit board.

In S120, in response to determining that the earphone is in the wearing state, a communication performance parameter of the earphone is acquired.

In some embodiments, the earphone may be in communication with the electronic device. The communication performance parameter may be a value of a received signal strength indication (RSSI). For example, when the method is performed by the earphone, the communication performance parameter of the earphone may be the received signal strength indication of a signal sent by the electronic device and received by the earphone. When the method is performed by the electronic device, the communication performance parameter of the earphone may be the received signal strength indication of a signal sent by the earphone and received by the electronic device. In some embodiments, the communication performance parameter may also be a value of a received channel power indicator (RCPI). The present disclosure does not limit this, and those skilled in the art may make a selection according to actual requirements.

In some embodiments, an antenna structure of the earphone is configured such that the earphone has different radiation performances when worn on the left ear and the right ear. For example, a radiation performance of an antenna usually has a certain directivity, the radiation performance may be optimized based on the left ear during a design process of the earphone. In this case, the communication performance parameter when the earphone is worn on the left ear is superior to the communication performance parameter when the earphone is worn on the right ear. That is, the antenna structure of the earphone causes the communication performance parameters when the earphone is worn on the left ear and the right ear to be different.

In some embodiments, a relative positional relationship between the earphone and the electronic device also affects the communication performance parameter of the earphone. For example, when the earphone is worn on the left ear, if the electronic device is placed on a left side of a sagittal plane of a human body, a communication distance between the earphone and the electronic device is short, and an antenna signal of the earphone is not easily blocked by a head, and then the communication performance parameter of the earphone is relatively good. If the electronic device is placed on a right side of the sagittal plane of the human body relative to the head of the user, the communication distance between the earphone and the electronic device is long, and the antenna signal of the earphone is easily blocked by the head, and then the communication performance parameter of the earphone is relatively poor. That means, the relative positional relationship between the earphone and the electronic device also causes the communication performance parameters when the earphone is worn on the left ear and the right ear to be different.

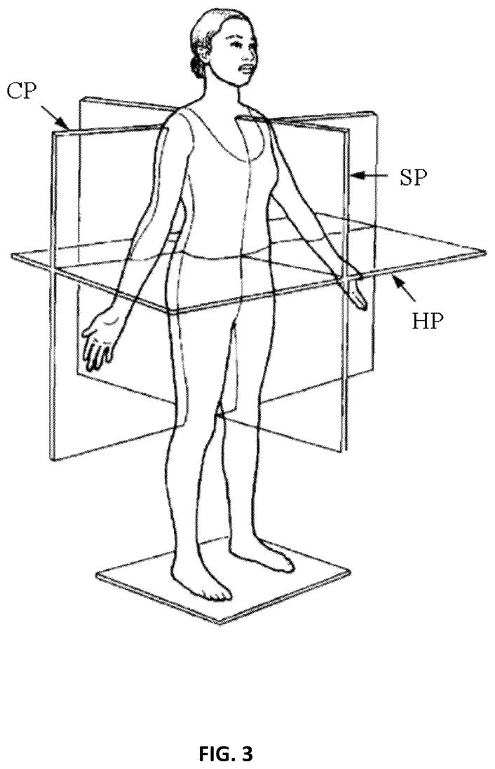

In some embodiments, as shown in FIG. 3, FIG. 3 is a schematic diagram of a human body section. In fields such as medicine and anatomy, three basic sections of the human body may be defined as a sagittal plane (SP), a coronal plane (CP), and a horizontal plane (HP). The sagittal plane refers to a section made along an anteroposterior direction of the body and perpendicular to the ground, which divides the human body into a left part and a right part. The coronal plane refers to a section made along a left-right direction of the body and perpendicular to the ground, which divides the human body into a front part and a rear part. The horizontal plane refers to a section parallel to the ground, which divides the human body into an upper part and a lower part.

In S130, the wearing position of the earphone is determined according to the communication performance parameter of the earphone.

In some embodiments, the antenna structure of the earphone causes communication performance parameters when the earphone is worn on the left ear and the right ear to be different, and the relative positional relationship between the earphone and the electronic device also causes communication performance parameters when the earphone is worn on the left ear and the right ear to be different. Therefore, the wearing position of the earphone may be determined according to the communication performance parameter of the earphone.

In some embodiments of the present disclosure, there is no need to additionally set detection components (e.g., an acceleration sensor and/or a gyroscope) in the earphone by obtaining the communication performance parameter of the earphone and determining the wearing position of the earphone according to the communication performance parameter of the earphone. Compared with the related technologies, the embodiments of the present disclosure can reduce hardware costs and be conducive to achieving the miniaturization of the earphone.

In some embodiments, when the user wears the earphone on a single ear (for example, there is only one earphone worn on a single ear, or there are two earphones arranged in a pair but the user wears only one of the two earphones, and the other earphone is still placed in an earphone case), the wearing position of the earphone may be detected by adjusting the relative positional relationship between the earphone and the electronic device to cause a change in the communication performance parameter of the earphone.

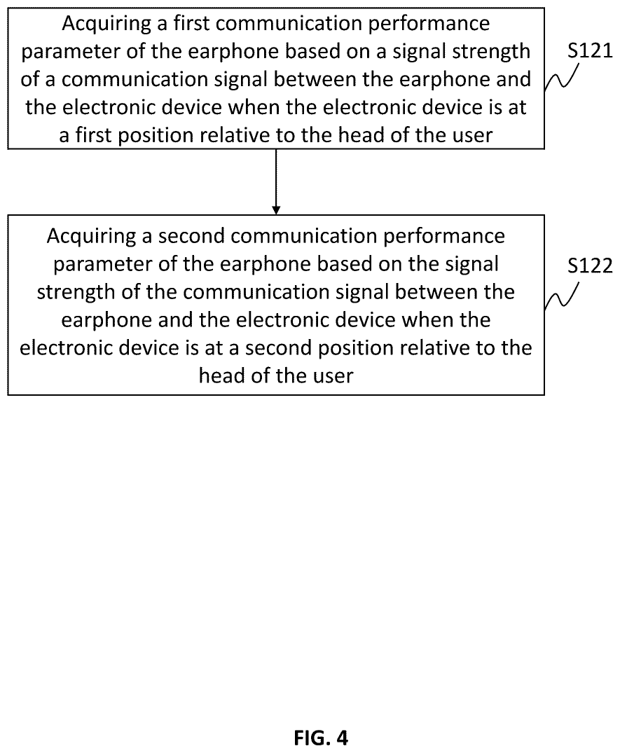

FIG. 4 is a flowchart illustrating an exemplary process of operation S120 according to some embodiments of the present disclosure. As shown in FIG. 4, the acquiring the communication performance parameter of the earphone includes the following operations.

In S121, a first communication performance parameter of the earphone is acquired based on a signal strength of a communication signal between the earphone and the electronic device when the electronic device is at a first position relative to the head of the user.

In S122, a second communication performance parameter of the earphone is acquired based on the signal strength of the communication signal between the earphone and the electronic device when the electronic device is at a second position relative to the head of the user.

In some embodiments, operation S130 is implemented by the following operations.

In S131, the wearing position of the earphone is determined according to a comparison result of the first communication performance parameter and the second communication performance parameter, wherein the first position and the second position are different, a difference exists between the first communication performance parameter and the second communication performance parameter.

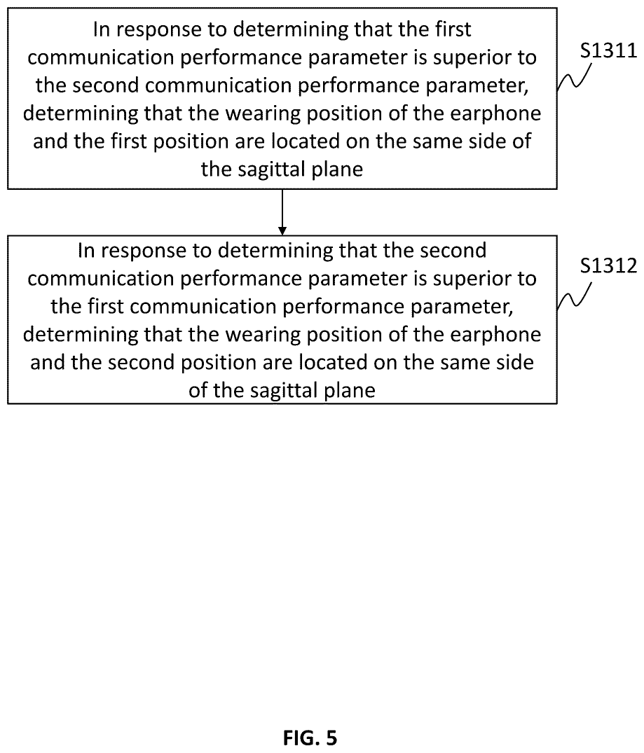

In some embodiments, the first position and the second position are located on opposite sides of a sagittal plane of the user. FIG. 5 is a flowchart illustrating an exemplary process of operation S131 according to some embodiments of the present disclosure. As shown in FIG. 5, operation S131 is implemented by the following operations.

In S1311, in response to determining that the first communication performance parameter is superior to the second communication performance parameter, it is determined that the wearing position of the earphone and the first position are located on the same side of the sagittal plane.

In S1312, in response to determining that the second communication performance parameter is superior to the first communication performance parameter, it is determined that the wearing position of the earphone and the second position are located on the same side of the sagittal plane.

It should be noted that operation S1311 and operation S1312 are mutually exclusive and do not occur simultaneously, so that there is no sequential order between operation S1311 and operation S1312.

In some embodiments, the first position is located on a left side of the sagittal plane, and the second position is located on a right side of the sagittal plane. If the first communication performance parameter corresponding to the first position is superior to the second communication performance parameter corresponding to the second position, it indicates that the first position is closer to the earphone or that the head causes less obstruction to the antenna signal of the earphone at the first position. In this case, the earphone is worn on the left side of the sagittal plane, i.e., the left ear.

In some embodiments, the first position is located on the left side of the sagittal plane, and the second position is located on the right side of the sagittal plane. If the second communication performance parameter corresponding to the second position is superior to the first communication performance parameter corresponding to the first position, it indicates that the second position is closer to the earphone or that the head causes less obstruction to the antenna signal of the earphone at the second position. In this case, the earphone is worn on the right side of the sagittal plane, i.e., the right ear.

It is easy to understand that the first communication performance parameter corresponding to the first position is affected by two factors, i.e., a distance between the first position and the earphone and a degree of obstruction of the antenna signal of the earphone caused by the head at the first position. The second communication performance parameter corresponding to the second position is affected by two factors, i.e., a distance between the second position and the earphone, and a degree of obstruction of the antenna signal of the earphone caused by the head the second position.

Merely by way of example, assume that the earphone is worn on the left ear, if the first position is located on the left side of the sagittal plane but is relatively far from the left ear, e.g., located at a position below the waist. The second position is located on the right side of the sagittal plane but is relatively close to the left ear, e.g., the second position is located at a position above the waist and below the head, the second communication performance parameter corresponding to the second position may be superior to the first communication performance parameter corresponding to the first position. In this case, if the earphone is worn on the right side of the sagittal plane, i.e., the right ear, an incorrect determination may occur.

Therefore, a distance between the first position and the earphone and a distance between the second position and the earphone may be controlled to be substantially the same to improve the accuracy of wearing position detection. In this case, the first communication performance parameter corresponding to the first position and the second communication performance parameter corresponding to the second position are mainly affected by the degree of obstruction of the antenna signal of the earphone caused by the head, thereby reducing the probability of incorrect determination.

In some embodiments, the shortest linear distance between the electronic device and a tragus E19 (labeled in FIG. 1) is less than or equal to 8 mm when the electronic device is at the first position, and the shortest linear distance between the electronic device and the tragus is less than or equal to 8 mm when the electronic device is at the second position.

When the electronic device is at the first position and the second position, it is very close to the ear. On one hand, the distance between the first position and the earphone and the distance between the second position and the earphone are substantially the same, thereby reducing the probability of incorrect determination and improving the accuracy of detecting the wearing position.

On the other hand, when the first position and the second position are respectively close to the ear, if the earphone is worn on the left ear, at the first position, the antenna signal of the earphone is substantially not obstructed by the head. At the second position, the antenna signal of the earphone is obstructed by the head to a greater extent. The difference between the first communication performance parameter and the second communication performance parameter is relatively obvious, which is beneficial to improve the accuracy of wearing position detection.

In some embodiments, the obtaining the communication performance parameter of the earphone can also include the following operations.

In S123, a predetermined action prompt is generated to cause the user to change a relative position between the electronic device and the head of the user according to a predetermined manner.

For example, when the user wears the earphone on a single ear, the user may be prompted to bring the electronic device close to the left ear first, and then the first communication performance parameter is obtained based on the signal strength of the communication signal between the earphone and the electronic device. After obtaining the first communication performance parameter, the user may be prompted to bring the electronic device close to the right ear, and then obtain the second communication performance parameter based on the signal strength of the communication signal between the earphone and the electronic device. In some embodiments, the predetermined action prompt may be issued to the user in a form of voice, etc., but the present disclosure does not limit the form, and those skilled in the art can make selections according to actual requirements.

It should be noted that although an operation number of operation S123 is after an operation number of operation S121 and an operation number of operation S122, the operation numbers in the description of the present disclosure do not indicate a necessary sequential order. For example, operation S123 is not necessarily executed after operations S121 and S122.

In some embodiments, the first position and the second position may also be located on a same side of the sagittal plane. For example, the first position and the second position may both be located on the left side of the sagittal plane, and the first position and the second position are arranged at an interval along a vertical direction. One of the first position and the second position is close to the left ear, and the other the first position and the second position is located above a top of the head. If the difference between the first communication performance parameter corresponding to the first position and the second communication performance parameter corresponding to the second position is large, the earphone may be worn on the right ear (one position is obstructed by the head and the other position is not obstructed by the head, so the difference is large). If the difference is small, the earphone may be worn on the left ear (both positions are not obstructed by the head).

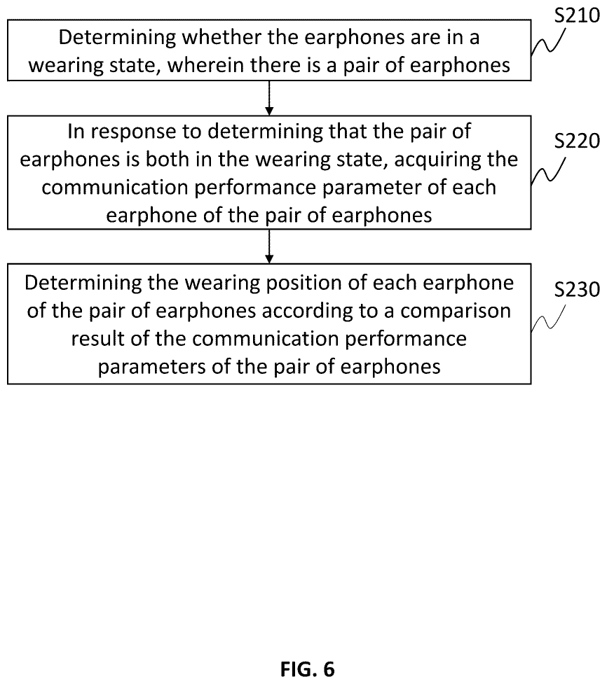

FIG. 6 is a flowchart illustrating an exemplary process of a method for detecting a wearing position of an earphone according to some embodiments of the present disclosure. As shown in FIG. 6, the method is used to determine the wearing position of each earphone when the user wears earphones on both ears simultaneously (e.g., there is a pair of earphones). In some embodiments, the method includes the following operations:

In S210, whether the earphones are in a wearing state is determined, wherein there is a pair of earphones.

In some embodiments, for each earphone, whether the earphone is in the wearing state may be determined. More descriptions regarding a specific determination manner may be found in related descriptions above, and details are not repeated herein.

In S220, in response to determining that the pair of earphones is both in the wearing state, the communication performance parameter of each earphone of the pair of earphones is acquired.

In S230, the wearing position of each earphone of the pair of earphones is determined according to a comparison result of the communication performance parameters of the pair of earphones.

In some embodiments of the present disclosure, when the user wears earphones on both ears, the wearing position of each earphone can be determined according to the comparison result of the communication performance parameters of the two earphones. It is not necessary to additionally set detection elements (e.g., the acceleration sensor and/or the gyroscope) in the earphones, thereby reducing hardware costs and being beneficial to achieve the miniaturization of the earphones.

In some embodiments, the antenna structure of each earphone is configured to have different radiation performance when worn on the left ear and the right ear. When the user wears earphones on both ears simultaneously, the wearing position of each earphone may be determined based on a difference between the communication performance parameters of the two earphones caused by the antenna structure of the earphones.

In some embodiments, for each earphone of the pair of earphones, an antenna structure of the earphone is configured such that the communication performance parameter of the earphone when worn on one of the left ear and the right ear is superior to the communication performance parameter when worn on the other of the left ear and the right ear. Merely by way of example, the communication performance parameter of each earphone when worn on the left ear is superior to the communication performance parameter when worn on the right ear. For example, the radiation performance of the antenna usually has a certain directivity. During the design process of the earphone, the radiation performance may be optimized based on the left ear, so that the earphone has relatively better communication performance when worn on the left ear.

In some embodiments, the obtaining the communication performance parameter of each earphone may be implemented by the following operations.

In S221, for each earphone of the pair of earphones, the communication performance parameter of the earphone is acquired based on a signal strength of a communication signal between the earphone and the electronic device when the electronic device is at a preset position relative to the head of the user, and the preset position is located on a sagittal plane of the user.

In some embodiments, S230 is implemented by the following operations.

In S231, the wearing position of one of the pair of earphones having a superior communication performance parameter is the one of the left ear and the right ear, and the wearing position of the other of the pair of earphones is the other of the left ear and the right ear.

In some embodiments, if the communication performance parameter of each earphone when worn on the left ear is superior to the communication performance parameter when worn on the right ear, the earphone with the superior communication performance parameter is worn on the left ear, and the other earphone is worn on the right ear. In some embodiments, the communication performance parameter of each earphone when worn on the right ear may also be superior to the communication performance parameter when worn on the left ear, which is not limited in the present disclosure, and those skilled in the art can make selections according to actual requirements.

In some embodiments of the present disclosure, the communication performance parameters of the two earphones are obtained when the electronic device is on the sagittal plane, communication distances between the two earphones and the electronic device are substantially the same, thereby avoiding the influence of the communication distance between the earphone and the electronic device on the communication performance parameter of the earphone, and improving the accuracy of wearing position detection.

In some embodiments, the communication performance parameter is a received signal strength indication (RSSI), and a difference between the RSSIs of the pair of earphones is a range of 5 dB to 10 dB. The difference between the communication performance parameters of the two earphones is reasonably set, so that the communication performance parameters of the two earphones are different, the wearing positions of the two earphones are detected, and avoiding that the difference is too large to affect the user experience.

In some embodiments, the obtaining the communication performance parameter of each earphone may also include the following operations.

In S222, the predetermined action prompt is generated to cause the user to change the relative position between the electronic device and the head of the user according to the predetermined manner.

For example, after determining that the user wears earphones on both ears simultaneously, the user may be prompted to place the electronic device on the sagittal plane, and then the communication performance parameter of each earphone is obtained based on the signal strength of the communication signal between each earphone and the electronic device. In some embodiments, the predetermined action prompt may be issued to the user in the form of voice. The present disclosure does not limit the form for issuing the predetermined action prompt, and those skilled in the art can make selections according to actual requirements.

In some embodiments, the antenna structure of each earphone may also be configured to have the same communication performance parameter when worn on the left ear and the right ear. When the user wears earphones on both ears simultaneously, the wearing position of each earphone may be determined based on the difference between the communication performance parameters of the two earphones caused by the relative positional relationship between the earphones and the electronic device.

In some embodiments, the acquiring the communication performance parameter of each earphone of the pair of earphones includes the following operations.

InS225, for each earphone of the pair of earphones, the communication performance parameter of the earphone is acquired based on a signal strength of a communication signal between the earphone and the electronic device when the electronic device is at a preset position relative to the head of the user, wherein the preset position is configured such that a difference exists between the communication performance parameter of the earphone worn on the left ear and the communication performance parameter of the earphone worn on the right ear.

Merely by way of example, the preset position may be located on one side of a sagittal plane of the user. Since the communication distance between the earphone worn on the left ear and the electronic device and the communication distance between the earphone worn on the right ear and the electronic device are different, the communication performance parameters of the earphone worn on the left ear and the earphone worn on the right ear are different. The wearing position of each earphone may be determined based on the comparison result of the communication performance parameters of the two earphones.

In some embodiments, S230 may be implemented by the following operations.

In S235, in response to determining that the communication performance parameter of one of the pair of earphones is superior to the communication performance parameter of the other of the pair of earphones, it is determined that the wearing position of the one of the pair of earphones and the preset position are located on the same side of the sagittal plane, and the wearing position of the other of the pair of earphones is located on an opposite side of the sagittal plane relative to the preset position.

Merely by way of example, if the preset position is located on the left side of the sagittal plane, it may be determined that the earphone with the superior communication performance parameter is worn on the left ear, and the other earphone is worn on the right ear.

In some embodiments, the manner described above may be performed twice consecutively to verify the detection result. The preset position may include a first position and a second position located on opposite sides of the sagittal plane. For example, the first position is located on one side of the sagittal plane, and the second position is located on the other side of the sagittal plane. The electronic device is placed at the first position to obtain a detection result of the wearing position; the electronic device is placed at the second position to obtain another detection result of the wearing position; and the two detection results are compared. In response to determining that the detection result of the wearing position obtained based on the first position is different from the detection result of the wearing position obtained based on the second position, an error prompt is generated. In this way, when an error occurs in the detection result of the wearing position, the error can be discovered in time to avoid affecting the user experience.

In some embodiments, the obtaining the communication performance parameter of each earphone may further include the following operations.

In S226, a predetermined action prompt is generated to cause the user to change a relative position between the electronic device and the head of the user according to a predetermined manner.

For example, after determining that the earphones are worn on both ears of the user simultaneously, the user may be prompted to place the electronic device on one side of the sagittal plane, and then the communication performance parameter of each earphone is obtained based on the signal strength of the communication signal between each earphone and the electronic device. In some embodiments, the predetermined action prompt may be issued to the user in the form of voice. Of course, the present disclosure does not limit the form of the predetermined action prompt, and those skilled in the art may make selections according to actual requirements.

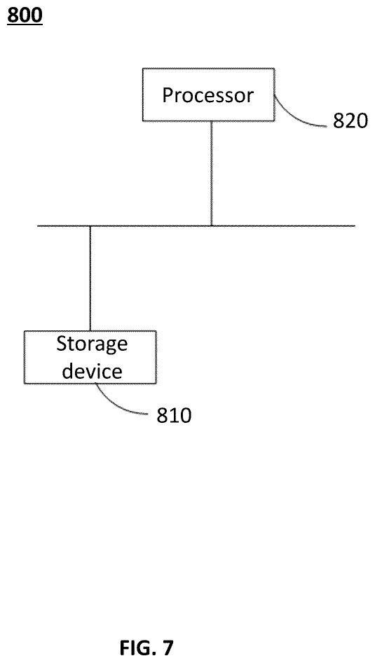

Some embodiments of the present disclosure further provide an earphone 800. FIG. 7 is a block diagram of an earphone according to some embodiments of the present disclosure. As shown in FIG. 7, the earphone 800 includes a storage device 810 and a processor 820, the storage device 810 stores a computer program, and the processor 820 is configured to execute the computer program to implement any method described above.

In some embodiments, the processor 820 may also be referred to as a CPU (Central Processing Unit). The processor 820 may be an integrated circuit chip with signal processing capability. The processor 820 may also be a general-purpose processor, a digital signal processor (DSP), an application specific integrated circuit (ASIC), a field programmable gate array (FPGA) or other programmable logic device, discrete gate or transistor logic device, or discrete hardware component. The general-purpose processor may be a microprocessor, or the processor 820 may be any conventional processor, etc.

In some embodiments, the storage device 810 may include a random-access storage device (RAM), a read-only storage device (ROM), a flash storage device, an erasable programmable read-only storage device (EPROM), an electrically erasable programmable read-only storage device (EEPROM), a register, a hard disk, a removable disk, a CD-ROM, etc. The storage device 810 may store program data. The program data may include a single instruction or a plurality of instructions, and may be distributed in several different code segments, distributed among different programs, and distributed across a plurality of storage devices. In some embodiments, the storage device 810 may be coupled to the processor 820 such that the processor 820 may read/write information from/to the storage device 810. In some embodiments, the storage device 810 may be integrated into the processor 820. The present disclosure does not limit the connection manner of the storage device 810 and the processor 820, and those skilled in the art may make selections according to actual requirements.

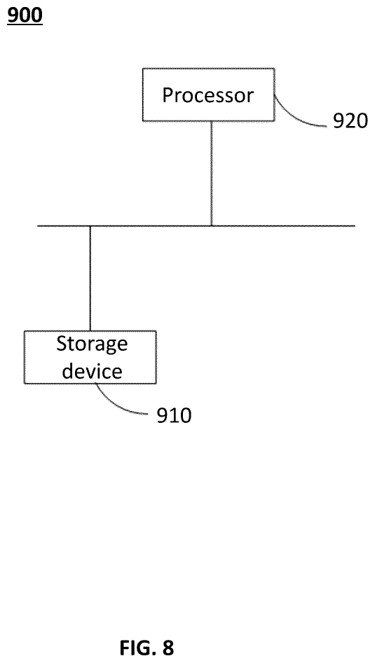

Some embodiments of the present disclosure further provide an electronic device 900. FIG. 8 is a block diagram of an electronic device according to some embodiments of the present disclosure. As shown in FIG. 8, the electronic device 900 includes a storage device 910 and a processor 920, the storage device 910 stores a computer program, and the processor 920 is configured to execute the computer program to implement any method described above.

The electronic device 900 may specifically be a mobile phone, a tablet, or a computer that communicates with the earphone 800, which is not limited in the present disclosure, and those skilled in the art may make selections according to actual requirements.

In some embodiments, the processor 920 may also be referred to as a CPU (Central Processing Unit). The processor 920 may be an integrated circuit chip with signal processing capability. The processor 920 may also be a general-purpose processor, a digital signal processor (DSP), an application specific integrated circuit (ASIC), a field programmable gate array (FPGA) or other programmable logic device, discrete gate or transistor logic device, or discrete hardware component. The general-purpose processor may be a microprocessor, or the processor 920 may be any conventional processor, etc.

In some embodiments, the storage device 910 may include a random-access storage device (RAM), a read-only storage device (ROM), a flash storage device, an erasable programmable read-only storage device (EPROM), an electrically erasable programmable read-only storage device (EEPROM), a register, a hard disk, a removable disk, a CD-ROM, etc. The storage device 910 may store program data. The program data may include, e.g., a single instruction or multiple instructions, and may be distributed in several different code segments, distributed among different programs, and distributed across multiple memories. In some embodiments, the storage device 910 may be coupled to the processor 920 such that the processor 920 may read/write information from/to the storage device 910. In some embodiments, the storage device 910 may be integrated into the processor 920. The present disclosure does not limit the connection manner of the storage device 910 and the processor 920, and those skilled in the art may make selections according to actual requirements.

In the several embodiments provided in the present disclosure, it should be understood that the disclosed method may be implemented in other manners. For example, the earphone/electronic device embodiments described above are merely illustrative. For example, the division of modules or units is merely a logical function division. In actual implementation, there may be another division manner. For example, multiple units or components may be combined or integrated into another system, or some features may be omitted or not executed. In addition, the mutual coupling or direct coupling or communication connection shown or discussed may be indirect coupling or communication connection through some interfaces, devices, or units, and may be electrical, mechanical, or in other forms.

The units described as separate components may or may not be physically separate. The components displayed as units may or may not be physical units, i.e., may be located in one place, or may be distributed on multiple network units. Some or all of the units may be selected according to actual requirements to achieve the objectives of some embodiments of the present embodiments.

In addition, the functional units in the various embodiments of the present disclosure may be integrated into one processing unit, or each unit may exist alone physically, or two or more units may be integrated into one unit. The above integrated unit may be implemented in the form of hardware, or may be implemented in the form of a software functional unit.

The above descriptions are only partial embodiments of the present disclosure, and are not intended to limit the scope of protection of the present disclosure. Any equivalent device or equivalent process transformation made by using the contents of the specification and drawings of the present disclosure, or direct or indirect application in other related technical fields, shall similarly be included in the scope of patent protection of the present disclosure.

What is claimed is:

1. A method for detecting a wearing position of an earphone, wherein the wearing position comprises a left ear or a right ear of a user, and the method comprises:
determining whether the earphone is in a wearing state;
in response to determining that the earphone is in the wearing state,
acquiring a communication performance parameter of the earphone; and
determining the wearing position of the earphone according to the communication performance parameter of the earphone.

2. The method according to claim 1, wherein an antenna structure of the earphone is configured such that the earphone has different radiation performances when worn on the left ear and the right ear of the user.

3. The method according to claim 1, wherein the earphone is in communication with an electronic device,
the acquiring a communication performance parameter of the earphone comprises:
acquiring a first communication performance parameter of the earphone based on a signal strength of a communication signal between the earphone and the electronic device when the electronic device is at a first position relative to the head of the user; and
acquiring a second communication performance parameter of the earphone based on the signal strength of the communication signal between the earphone and the electronic device when the electronic device is at a second position relative to the head of the user;
the determining the wearing position of the earphone according to the communication performance parameter of the earphone comprises:
determining the wearing position of the earphone according to a comparison result of the first communication performance parameter and the second communication performance parameter, wherein the first position and the second position are different, a difference exists between the first communication performance parameter and the second communication performance parameter.

4. The method according to claim 3, wherein the first position and the second position are located on a same side of a sagittal plane of the user.

5. The method according to claim 4, wherein the first position and the second position are arranged at an interval along a vertical direction.

6. The method according to claim 3, wherein the first position and the second position are located on opposite sides of a sagittal plane of the user, and
the determining the wearing position of the earphone according to a comparison result of the first communication performance parameter and the second communication performance parameter comprises:
in response to determining that the first communication performance parameter is superior to the second communication performance parameter, determining that the wearing position of the earphone and the first position are located on the same side of the sagittal plane;
in response to determining that the second communication performance parameter is superior to the first communication performance parameter, determining that the wearing position of the earphone and the second position are located on the same side of the sagittal plane.

7. The method according to claim 3, wherein the shortest linear distance between the electronic device and a tragus is less than or equal to 8 mm when the electronic device is at the first position, and the shortest linear distance between the electronic device and the tragus is less than or equal to 8 mm when the electronic device is at the second position.

8. The method according to claim 1, wherein there is a pair of earphones,
the acquiring a communication performance parameter of the earphone comprises:
in response to determining that the pair of earphones both are in the wearing state, acquiring the communication performance parameter of each earphone of the pair of earphones;
the determining the wearing position of the earphone according to the communication performance parameter of the earphone comprises:
determining the wearing position of each earphone of the pair of earphones according to a comparison result of the communication performance parameters of the pair of earphones.

9. The method according to claim 8, wherein each earphone of the pair of earphones earphone is configured to have the same communication performance parameter when worn on the left ear and the right ear, and
the determining the wearing position of each earphone of the pair of earphones according to a comparison result of the communication performance parameters of the pair of earphones includes:
when the user wears earphones on both ears simultaneously, determining the wearing position of each earphone of the pair of earphones based on a difference between the communication performance parameters of the pair of earphones caused by a relative positional relationship between the earphones and the electronic device.

10. The method according to claim 8, wherein
for each earphone of the pair of earphones, an antenna structure of the earphone is configured such that the communication performance parameter of the earphone when worn on one of the left ear and the right ear is superior to the communication performance parameter when worn on the other of the left ear and the right ear;
the determining the wearing position of each earphone of the pair of earphones according to a comparison result of the communication performance parameters of the pair of earphones comprises:
determining that the wearing position of one of the pair of earphones having a superior communication performance parameter is the one of the left ear and the right ear, and the wearing position of the other of the pair of earphones is the other of the left ear and the right ear.

11. The method according to claim 10, wherein each earphone of the pair of earphones is in communication with an electronic device, and the acquiring the communication performance parameter of each earphone of the pair of earphones comprises:
for each earphone of the pair of earphones, acquiring the communication performance parameter of the earphone based on a signal strength of a communication signal between the earphone and the electronic device when the electronic device is at a preset position relative to the head of the user, and the preset position is located on a sagittal plane of the user.

12. The method according to claim 11, wherein the communication performance parameter is a received signal strength indication (RSSI), and a difference between the RSSIs of the pair of earphones is a range of 5 dB to 10 dB.

13. The method according to claim 8, wherein the earphone is in communication with an electronic device, and the acquiring the communication performance parameter of each earphone of the pair of earphones comprises:
for each earphone of the pair of earphones, acquiring the communication performance parameter of the earphone based on a signal strength of a communication signal between the earphone and the electronic device when the electronic device is at a preset position relative to the head of the user, wherein the preset position is configured such that a difference exists between the communication performance parameter of the earphone worn on the left ear and the communication performance parameter of the earphone worn on the right ear.

14. The method according to claim 13, wherein the preset position is located on one side of a sagittal plane of the user;
the determining the wearing position of each earphone of the pair of earphones according to a comparison result of the communication performance parameters of the pair of earphones comprises:
in response to determining that the communication performance parameter of one of the pair of earphones is superior to the communication performance parameter of the other of the pair of earphones, determining that the wearing position of the one of the pair of earphones and the preset position are located on the same side of the sagittal plane, and the wearing position of the other of the pair of earphones is located on an opposite side of the sagittal plane relative to the preset position.

15. The method according to claim 14, wherein the preset position comprises a first position and a second position located on opposite sides of the sagittal plane, and the method further comprises:
in response to determining that a detection result of the wearing position obtained based on the first position is different from a detection result of the wearing position obtained based on the second position, generating an error prompt.

16. The method according to claim 1, wherein the earphone is in communication with an electronic device, and the acquiring a communication performance parameter of the earphone further comprises:
generating a predetermined action prompt to cause the user to change a relative position between the electronic device and the head of the user according to a predetermined manner.

17. The method according to claim 1, wherein the communication performance parameter includes at least one of a received signal strength indication (RSSI) or a received channel power indicator (RCPI).

18. The method according to claim 1, wherein the earphone is in communication with an electronic device, and the determining the wearing position of the earphone according to the communication performance parameter of the earphone includes:
when the user wears the earphone on a single ear, detecting the wearing position of the earphone by adjusting a relative positional relationship between the earphone and the electronic device to cause a change in the communication performance parameter of the earphone.

19. An earphone, comprising a processor and a storage device, wherein the storage device stores a computer program, and the processor is configured to execute the computer program to implement the method according to claim 1.

20. An electronic device, configured to communicate with an earphone, and comprising a processor and a storage device, wherein the storage device stores a computer program, and the processor is configured to execute the computer program to implement the method according to claim 1.
